(19) United States
(12) Patent Application Publication
(10) Pub. No.: US 2024/0257823 A1
(43) Pub. Date: Aug. 1, 2024

(54) SYSTEMS AND METHODS FOR REMOTE REAL-TIME AUDIO MONITORING

(71) Applicant: MIXHalo Corp., San Francisco, CA (US)

(72) Inventor: Carlos J. Morales Batista, Chicago, IL (US)

(21) Appl. No.: 18/521,676

(22) Filed: Nov. 28, 2023

Related U.S. Application Data
(60) Provisional application No. 63/441,968, filed on Jan. 30, 2023.

(51) Int. Cl. G10L 21/0232; G08B 21/18; G10L 19/022; G10L 21/0308

(52) U.S. Cl. CPC G10L 21/0232; G08B 21/182; G10L 19/022; G10L 21/0308

(57) ABSTRACT

A method for remotely monitoring audio signal variance in real-time by a cloud-based virtual host communicative coupled to an audio server computing device includes receiving and processing network packets that contain an audio signal. The method also includes calculating an audio signal variance based on the processed network packets containing the audio signal. The method also includes determining whether the audio signal variance is below a threshold and, in response to determining that the audio signal variance is below the threshold, generating an alert indicating that the audio signal variance is below the threshold.

### RELATED APPLICATION(S)

This application claims priority to U.S. Provisional Patent Application No. 63/441,968, filed on Jan. 30, 2023, the entirety of which is incorporated by reference herein.

### FIELD OF THE INVENTION

This invention relates generally to the field of audio monitoring and analysis. More specifically, the invention relates to systems and methods for generating alerts based on remote real-time monitoring of audio variance.

### BACKGROUND

Facilities hosting live events typically have audio engineers on-site that can address any issues that may arise with audio signal or sound quality. Generally, the audio engineers at live events rely on perceived or observed changes in volume levels to detect issues with one or more audio signals. However, relying on observed changes in volume levels may not always result in accurate audio issue detection because some volume level changes may be intentional. Further, requiring an on-site audio engineer for audio issue detection at every facility hosting a live event may be inefficient and/or uneconomical. Therefore, there is a need for systems and methods that can remotely detect audio signal or sound quality issues without relying on on-site perceived or observed changes in sound volume levels.

### SUMMARY

To overcome the above-identified challenges, the systems and methods described herein provide for remotely monitoring audio signal variance in real-time. For example, the systems and methods receive and process network packets containing an audio signal and calculate an audio signal variance based on the processed network packets containing the audio signal. The systems and methods further determine whether the audio signal variance is below a threshold and generate an alert indicating that the audio signal variance is below the threshold.

In one aspect, the invention includes a computerized method for remotely monitoring audio signal variance in real-time by a cloud-based virtual host. The computerized method includes receiving network packets containing an audio signal. The computerized method also includes processing the received network packets containing the audio signal. The computerized method also includes calculating an audio signal variance based on the processed network packets containing the audio signal. The computerized method also includes determining that the audio signal variance is below a threshold. The computerized method also includes generating an alert indicating that the audio signal variance is below the threshold.

In some embodiments, the computerized method further includes receiving the audio signal from an audio interface by an audio server computing device. For example, in some embodiments, the computerized method further includes generating the network packets containing the audio signal by the audio server computing device. In some embodiments, the computerized method further includes transmitting the network packets containing the audio signal to the cloud-based virtual host via a network.

In some embodiments, the computerized method further includes routing the network packets containing the audio signal to a docker image for processing. In some embodiments, the alert is a push notification to a mobile computing device.

In some embodiments, processing the network packets containing the audio signal includes calculating a Fast Fourier Transform (FFT) of the audio signal. For example, in some embodiments, processing the network packets containing the audio signal further includes grouping the calculated FFT of the audio signal into different frequency bands. In some embodiments, processing the network packets containing the audio signal further includes calculating a variance for each of the grouped frequency bands.

In some embodiments, the threshold is determined before the cloud-based virtual host receives the network packets containing the audio signal. In other embodiments, the threshold is determined after the cloud-based virtual host received the network packets containing the audio signal. For example, in some embodiments, the threshold is updated in real-time based on the processed network packets containing the audio signal.

In another aspect, the invention includes a system for remotely monitoring audio signal variance in real-time. The system includes a cloud-based virtual host communicatively coupled to an audio server computing device over a network. The cloud-based virtual host is configured to receive network packets containing the audio signal. The cloud-based virtual host is also configured to process the network packets containing the audio signal. The cloud-based virtual host is also configured to calculate an audio signal variance based on the processed network packets containing the audio signal. The cloud-based virtual host is also configured to determine that the audio signal variance is below a threshold. The cloud-based virtual host is also configured to generate an alert indicating that the audio signal variance is below the threshold.

In some embodiments, the audio server computing device is configured to receive the audio signal from an audio interface. For example, in some embodiments, the audio server computing device is further configured to generate the network packets containing the audio signal. In some embodiments, the audio server computing device is further configured to transmit the network packets containing the audio signal to the cloud-based virtual host via the network.

In some embodiments, the cloud-based virtual host is further configured to route the network packets containing the audio signal to a docker image for processing. In some embodiments, the alert is a push notification to a mobile computing device.

In some embodiments, the cloud-based virtual host is configured to process the network packets containing the audio signal by calculating a Fast Fourier Transform (FFT) of the audio signal. For example, in some embodiments, the cloud-based virtual host is further configured to process the network packets containing the audio signal by grouping the calculated FFT of the audio signal into different frequency bands. In some embodiments, the cloud-based virtual host is further configured to process the network packets containing the audio signal by calculating a variance for each of the grouped frequency bands.

In some embodiments, the threshold is determined before the cloud-based virtual host receives the network packets containing the audio signal. In other embodiments, the threshold is determined after the cloud-based virtual host received the network packets containing the audio signal. For example, in some embodiments, the threshold is updated in real-time based on the processed network packets containing the audio signal.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of data, according to an illustrative embodiment of the invention.

FIG. 2 is a schematic diagram of a system architecture for remote real-time audio monitoring, according to an illustrative embodiment of the invention.

FIG. 3 is a schematic diagram illustrating the spectral composition of several exemplary audio signals, according to an illustrative embodiment of the invention.

FIG. 4 is a schematic flow diagram of a process illustrating remote real-time audio monitoring using the system architecture of FIG. 2, according to an illustrative embodiment of the invention.

### DETAILED DESCRIPTION

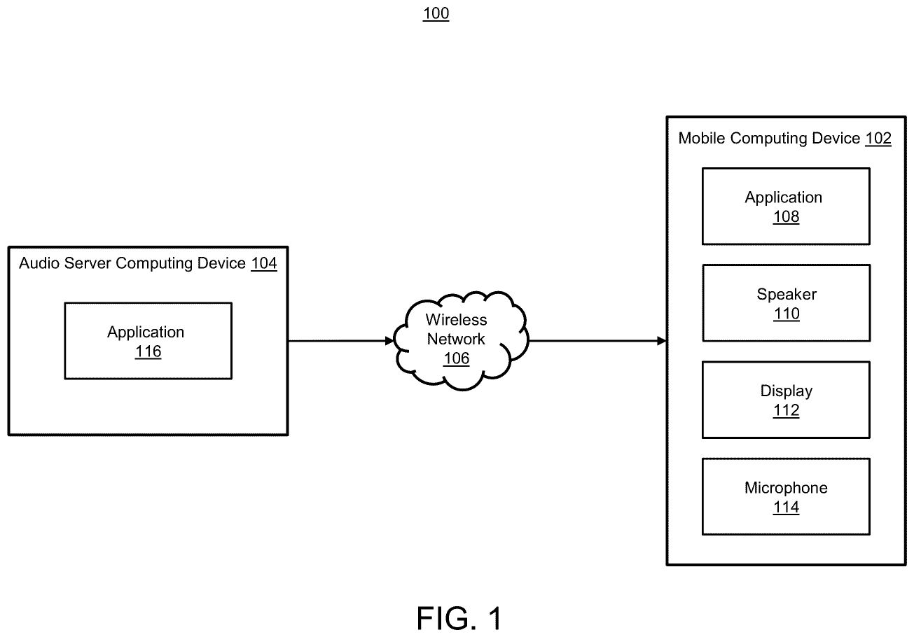

FIG. 1 is a schematic diagram of a system architecture 100 for real-time delivery of data, according to an illustrative embodiment of the invention. System 100 includes a mobile computing device 102 communicatively coupled to an audio server computing device 104 over a wireless network 106. Mobile computing device 102 includes an application 108, one or more speakers 110, a display 112, and one or more microphones 114.

Audio server computing device 104 is a computing device including specialized hardware and/or software modules that execute on one or more processor sand interact with memory modules of server computing device 104, to receive data from other components of system 100, transmit data to other components of system 100, and perform functions for real-time delivery of data as described herein, including but not limited to live audio and/or video data. Audio server computing device 104 includes application 116. In some embodiments, the audio server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung@Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices. An exemplary application 108 can be an app downloaded to and installed on mobile computing device 102 via, e.g., the Apple® App Store or the Google® Play Store. The user can launch application 108 on mobile computing device 102 and interact with one or more user interface elements displayed by the application 108 on a screen of mobile computing device 102 to begin receiving audio and/or video data from server computing device 104.

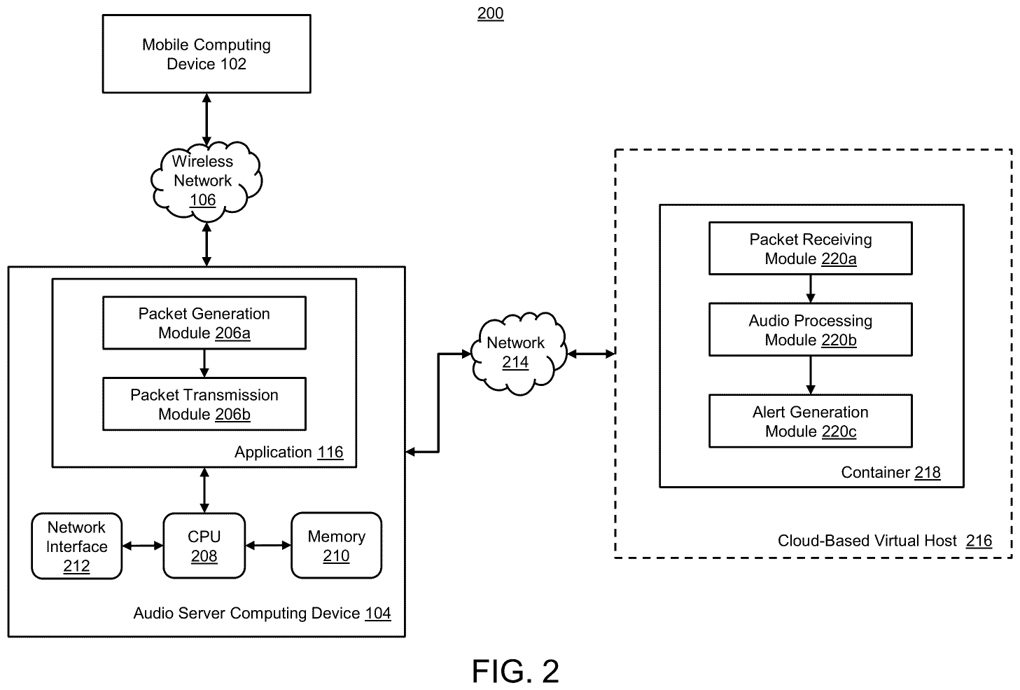

FIG. 2 is a schematic diagram of a system architecture 200 for remote real-time audio monitoring, according to an illustrative embodiment of the invention. The invention includes system 200 for remotely monitoring audio signal variance in real-time. System 200 includes audio server computing device 104 coupled to cloud-based virtual host 216 via network 214. In some embodiments, network 106 is the same network as network 214. In other embodiments, network 106 is different than network 214. For example, network 106 is a wireless network and network 214 is a wired network.

Audio server computing device 104 includes application 116 with packet generation module 206a and packet transmission module 206b. Audio server computing device 104 also includes CPU 208, memory 210, and network interface 212 (e.g., hardware that enables device 104 to connect to networks 106 and 214. Packet generation module 210a is configured to generate network data packets comprising an audio signal. Packet transmission module 210b is configured to transmit the generated network data packets to network 214. In some embodiments, the audio signal corresponds to a data representation of a live audio signal associated with a live event (e.g., concert, sporting event, etc.). In these embodiments, audio server computing device 104 can receive the audio signal as, e.g., a data stream from an audio interface such as another computing device and/or a soundboard at the live event.

Generally, modules 206a and 206b of application 116 are specialized sets of computer software instructions which execute on one or more processors of audio server computing device 104 (e.g., CPU 208). In some embodiments, modules 206a and 206b can specify designated memory locations and/or registers for executing the specialized computer software instructions.

Cloud-based virtual host 216 is a combination of hardware, including one or more computing devices comprised of special-purpose processors and one or more physical memory modules, and specialized software-such as container 218—executed by processor(s) of the server computing devices in a cloud computing environment, to receive and process audio signal packets from audio server computing device 104. Exemplary cloud computing platforms that can be used for cloud-based virtual host include, but are not limited to, Amazon® Web Services (AWS); IBM® Cloud™; and Microsoft® Azure™. It should be appreciated that other types of resource distribution, allocation, and configuration in a cloud-based computing environment can be used within the scope of the technology described herein.

In some embodiments, container 218 is deployed for execution as an independent process running on a server infrastructure (e.g., cloud environment). Each software container includes software elements such as code, runtime, system tools, settings, libraries, operating system functions, and the like that enable execution of one or more applications in the container. Examples of currently-available software container projects include Docker™, Open Container Initiative (OCI), and Amazon™ EC2 Containers.

As shown in FIG. 2, container 218 includes packet receiving module 220a and audio processing module 220b. Generally, modules 220a and 220b are specialized sets of computer software instructions which execute on one or more processors of computing devices that provide cloud-based virtual host 216. In some embodiments, modules 220a and 220b can specify designated memory locations and/or registers for executing the specialized computer software instructions.

As will be described in detail below, cloud-based virtual host 216 is configured to receive network packets containing the audio signal from, e.g., audio server computing device 104 via network 214. Cloud-based virtual host 202 is also configured to process the network packets containing the audio signal. The cloud-based virtual host is also configured to calculate an audio signal variance based on the processed network packets containing the audio signal. The cloud-based virtual host is also configured to determine that the audio signal variance is below a threshold. The cloud-based virtual host is also configured to generate an alert indicating that the audio signal variance is below the threshold.

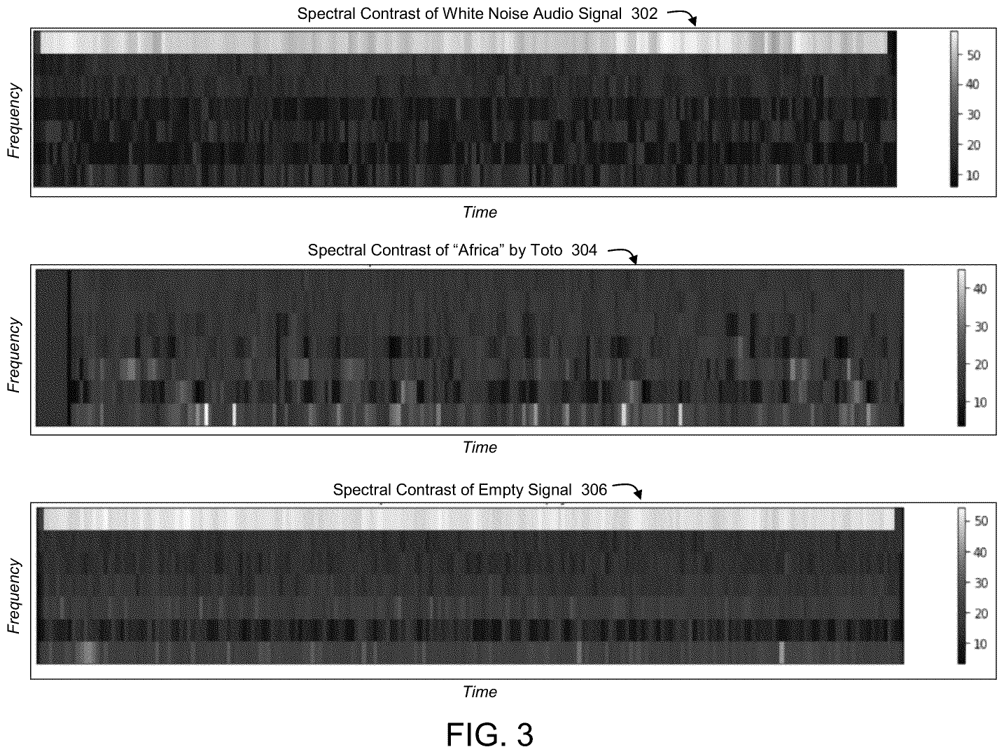

For example, FIG. 3 is a schematic diagram illustrating the spectral composition 300 of several exemplary audio signals, according to an illustrative embodiment of the invention. As shown in FIG. 3, image 302 represents the spectral composition of a white noise audio signal. Image 304 represents the spectral composition of an audio signal from the song “Africa” by the band Toto. Image 306 represents the spectral composition of an empty signal (i.e., no audio present). As can be appreciated, each spectral composition shown in FIG. 3 contains different spectral characteristics that can be monitored and analyzed by system 200 in real-time in order to identify whether the audio signal contains white noise or no content in the audio signal.

Turning back to FIG. 2, audio server computing device 104 is configured to receive the audio signal from an audio interface (not shown). Packet generation module 206a of application 116 in audio server computing device 104 generates one or more network packets containing the received audio signal. For example, packet generation module 206a can utilize one or more network protocols (e.g., HTTP) to generate the network packets. As can be appreciated, in some embodiments, packet generation module 206a samples a portion of the received audio signal and generates one or more network packets that contain the sampled audio. Packet transmission module 206b of application 116 in audio server computing device 104 transmits the network packets containing the audio signal to cloud-based virtual host 216 via network 214.

Cloud-based virtual host 216 receives the network packets generated by audio server computing device 104 and routes the network packets containing the audio signal to container 218 (e.g., a Docker™ image) for processing. Packet receiving module 220a of container 218 receives the packets containing the audio signal from host 216 and transmits the packets to audio processing module 220b.

Audio processing module 220b of container 218 processes the network packets to monitor audio signal variance in real-time.

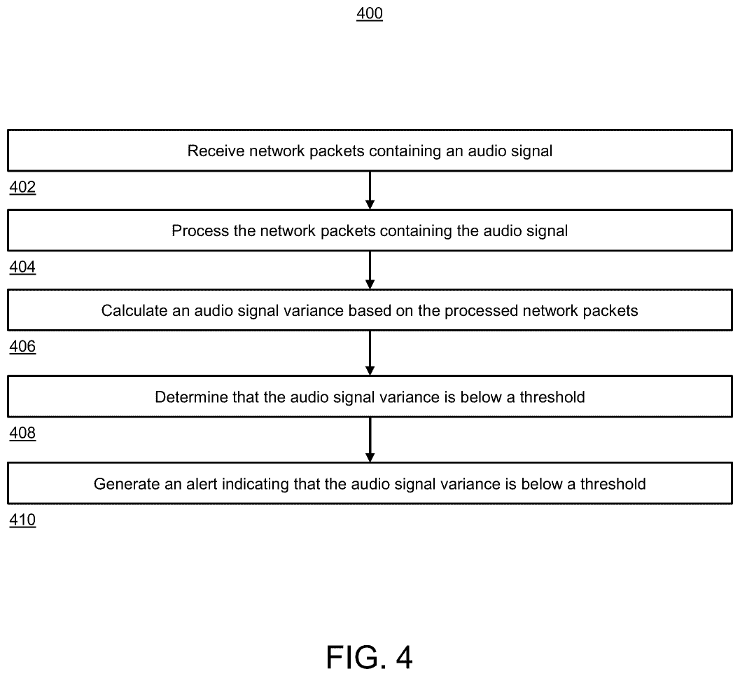

FIG. 4 is a schematic flow diagram of a process 400 illustrating remote monitoring of audio signal variance in real-time, using system 200 of FIG. 2. Process 400 begins by receiving network packets containing an audio signal at step 402. As described above, packet receiving module 220a of container 218 receives network packets containing the audio signal to be analyzed from audio server computing device 104 via network 214.

Process 400 continues by processing the received network packets containing the audio signal at step 404 and by calculating an audio signal variance based on the processed network packets containing the audio signal at step 406. For example, in some embodiments, audio processing module 220b processes the network packets containing the audio signal by calculating a Fast Fourier Transform (FFT) of the audio signal. As is generally understood, a FFT is a mathematical algorithm that decomposes an audio signal into its constituent frequencies, while also providing the magnitude of each frequency in the signal. Additional information about FFT algorithms and related spectrograms is described in K. Chaudhary, “Understanding Audio data, Fourier Transform, FFT and Spectrogram features for Speech Recognition System,” Towards Data Science, Jan. 19, 2020 (incorporated herein by reference). In some embodiments, processing the network packets containing the audio signal further includes grouping the calculated FFT of the audio signal into different frequency bands. For example, audio processing module 220b can group frequencies generated using the FFT according to defined frequency bands in a given frequency spectrum, e.g., 0 Hz to 60 Hz, 60 Hz to 250 Hz, etc. In some embodiments, processing the network packets containing the audio signal further includes calculating a variance for each of the grouped frequency bands. For example, audio processing module 220b can determine a variance of the frequency values in each band. As can be appreciated, an audio signal that contains speech and/or music typically exhibits a measurable variance in frequency within each frequency band. In contrast, an audio signal that contains no audio or only white noise typically exhibits minimal to no variance in frequency within each frequency band.

Process 400 continues by determining that the audio signal variance is below a threshold at step 408. For example, audio processing module 220b compares the audio signal variance for the audio signal in one or more of the frequency bands with one or more threshold values to determine whether the audio signal variance is above or below the threshold. In some embodiments, the threshold is determined before cloud-based virtual host 216 receives the network packets containing the audio signal from audio server computing device 104. For example, audio server computing device 104 can be configured to determine a threshold to be associated with the incoming audio signal and transmit the threshold along with the audio signal to cloud-based virtual host 216. In other embodiments, the threshold is determined after cloud-based virtual host 216 receives the network packets containing the audio signal. For example, as audio processing module 220b receives and processes the network packets, module 220b can calculate a threshold to be used for comparing the audio signal variance. In some embodiments, the threshold is updated in real-time by audio processing module 220b based on the processed network packets containing the audio signal. Generally, an audio signal variance that is below the threshold indicates that the audio signal comprises white noise or no audio.

Process 400 finishes by generating an alert indicating that the audio signal variance is below the threshold at step 410. For example, upon determining that the audio signal variance is below the defined threshold, audio processing module 220b can instruct alert generation module 220c to transmit an alert to, e.g., mobile computing device 102 via network 106 and audio server computing device 104. In some embodiments, the alert is a push notification to mobile computing device 102 to inform a user of mobile computing device 102 that there is an issue with the audio signal. The alert notification can be particularly helpful in the context of a live event to let attendees know that the live audio signal processing and delivery to mobile computing devices 102 may be unavailable or encountering technical issues.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM® Cloud).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD™, HD-DVD™, and Blu-ray™ disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth®, near field communications (NFC) network, Wi-Fi™, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Edge™ available from Microsoft Corporation, and/or Mozilla® Firefox available from Mozilla Corporation). Mobile computing device include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims.

What is claimed is:

1. A computerized method for remotely monitoring audio signal variance in real-time, the method comprising:
receiving, by a cloud-based virtual host, a plurality of network packets comprising an audio signal;
processing, by the cloud-based virtual host, the plurality of network packets comprising the audio signal;
calculating, by the cloud-based virtual host, an audio signal variance based on the processed plurality of network packets comprising the audio signal;
determining, by the cloud-based virtual host, that the audio signal variance is below a threshold; and
generating, by the cloud-based virtual host, an alert indicating that the audio signal variance is below the threshold.

2. The computerized method of claim 1, further comprising:
receiving, by an audio server computing device, the audio signal from an audio interface;
generating, by the audio server computing device, the plurality of network packets comprising the audio signal; and
transmitting, by the audio server computing device, the plurality of network packets to the cloud-based virtual host via a network.

3. The computerized method of claim 1, further comprising:
routing, by the cloud-based virtual host, the plurality of network packets comprising the audio signal to a docker image for processing.

4. The computerized method of claim 1, wherein processing the plurality of network packets comprising the audio signal comprises:
calculating, by the cloud-based virtual host, a Fast Fourier Transform (FFT) of the audio signal.

5. The computerized method of claim 4, wherein processing the plurality of network packets comprising the audio signal further comprises:
grouping, by the cloud-based virtual host, the calculated FFT of the audio signal into a plurality of frequency bands.

6. The computerized method of claim 5, wherein calculating the audio signal variance based on the processed plurality of network packets comprising the audio signal comprises:
calculating, by the cloud-based virtual host, a variance for each of the grouped plurality of frequency bands.

7. The computerized method of claim 1, wherein the threshold is determined before the cloud-based virtual host receives the plurality of network packets comprising an audio signal.

8. The computerized method of claim 1, wherein the threshold is determined after the cloud-based virtual host receives the plurality of network packets comprising an audio signal.

9. The computerized method of claim 8, wherein the threshold is updated in real-time based on the processed plurality of network packets comprising the audio signal.

10. The computerized method of claim 1, wherein the alert comprises a push notification to a mobile computing device.

11. A system for remotely monitoring audio signal variance in real-time, the system comprising:
a cloud-based virtual host communicatively coupled to an audio server computing device over a network, the cloud-based virtual host configured to:
receive a plurality of network packets comprising an audio signal;
process the plurality of network packets comprising the audio signal;
calculate an audio signal variance based on the processed plurality of network packets comprising the audio signal;
determine that the audio signal variance is below a threshold; and
generate an alert indicating that the audio signal variance is below the threshold.

12. The system of claim 11, wherein the audio server computing device is configured to:
receive the audio signal from an audio interface;
generate the plurality of network packets comprising the audio signal; and
transmit the plurality of network packets to the cloud-based virtual host via the network.

13. The system of claim 11, wherein the cloud-based virtual host is further configured to:
route the plurality of network packets comprising the audio signal to a docker image for processing.

14. The system of claim 11, wherein the cloud-based virtual host is configured to process the plurality of network packets comprising the audio signal by:
calculating a Fast Fourier Transform (FFT) of the audio signal.

15. The system of claim 14, wherein the cloud-based virtual host is further configured to process the plurality of network packets comprising the audio signal by:
grouping the calculated FFT of the audio signal into a plurality of frequency bands.

16. The system of claim 15, wherein the cloud-based virtual host if configured to calculate the audio signal variance based on the processed plurality of network packets comprising the audio signal by:
calculating a variance for each of the grouped plurality of frequency bands.

17. The system of claim 11, wherein the threshold is determined before the cloud-based virtual host receives the plurality of network packets comprising an audio signal.

18. The system of claim 11, wherein the threshold is determined after the cloud-based virtual host receives the plurality of network packets comprising an audio signal.

19. The system of claim 18, wherein the threshold is updated in real-time based on the processed plurality of network packets comprising the audio signal.

20. The system of claim 11, wherein the alert comprises a push notification to a mobile computing device.
